(19) United States
(12) Patent Application Publication
(10) Pub. No.: US 2023/0153879 A1
(43) Pub. Date: May 18, 2023

(54) ONLINE GENERATION METHOD FOR INSTALLMENT PRE-SALE CONTRACT

(71) Applicants: Yuefu FENG, Chengdu (CN); Sichuan Yuduobao Technology Co., Ltd., Chengdu (CN)

(72) Inventors: Yuefu FENG, Chengdu (CN); Yue LI, Chengdu (CN)

(21) Appl. No.: 18/154,586

(22) Filed: Jan. 13, 2023

Related U.S. Application Data
(63) Continuation of application No. PCT/CN2020/000273, filed on Nov. 11, 2020.

(30) Foreign Application Priority Data
Jul. 20, 2020 (CN) 202010707469.4

(51) Int. Cl. G06Q 30/0601; G06Q 10/087; G06Q 20/22

(52) U.S. Cl. CPC G06Q 30/0611; G06Q 10/087; G06Q 30/0635; G06Q 20/29

(57) ABSTRACT

An online generation method for an installment pre-sale contract of the present invention belongs to an online generation method for an installment pre-sale contract having an online constraint method in a contract generation process. The method comprises: a merchant and a client online mutually send data and invoke an inventory module in a server, modify the inventory module, and complete an offer; both parties modify an order online to become an agreement; an order having the identities of both parties and business transaction content is generated; each order installment is an independent and complete agreement document; a payment tool is added to convert the contract into an executable agreement; and a contract is generated by adding a business transaction agreement to a modified document formatting the clauses of the contract; and a contract execution reminder is combination information of time and execution business content.

### CROSS-REFERENCE TO RELATED APPLICATIONS

This application is a continuation of International Patent Application No. PCT/CN2020/000273 with a filing date of Nov. 11, 2020, designating the United States, now pending, and further claims priority to Chinese Patent Application No. 202010707469.4 with a filing date of Jul. 20, 2020. The content of the aforementioned applications, including any intervening amendments thereto, are incorporated herein by reference.

### TECHNICAL FIELD

The present invention belongs to the technical field of online contract generation between both parties of sales, in particular to an online generation method for an installment pre-sale contract having an online constraint method in a contract generation process.

### BACKGROUND OF THE PRESENT INVENTION

At present, JD.COM, Alibaba and Pinduoduo are all business-to-consumer commodity installment-sale and trading platforms. However, there is no relevant platform for raw material or service transactions between enterprises, especially for installment pre-sale transactions between the enterprises. The difficulty in installment pre-sale transactions is standardization of negotiation content and minimization of reverse negotiation when pre-sale contracts are generated online during pre-sales.

### SUMMARY OF PRESENT INVENTION

The purpose of the present invention is to provide a method for online and efficient generation of pre-sale contracts of merchants and clients with standardization of negotiation contents and minimization of reverse negotiation when the pre-sale contracts are generated online.

The method of the present invention is:

An online generation method for an installment pre-sale contract comprises: a merchant and a client online mutually send data and invoke an inventory module in a server, modify the inventory module, and complete an offer, an agreement, order generation, order installment, an executable agreement, contract generation and a contract execution reminder; and there is an online constraint method in a contract generation process. Specific steps are as follows:

(1) A merchant invokes an original order module in a server online, modifies same to multiple numbers of installments and changes same to a merchant offer order list of a multiple installment format having a commodity number, a price, a payment date, and a delivery date and other content having a modifiable range;

(2) The merchant sends the merchant offer order list to the server for saving and external issuance;

(3) A client invokes the merchant offer order list online, selects the merchant offer order list of one installment manner in the multiple numbers of installments, and modifies the commodity number, price, payment date, and delivery date and other offer content into a client response order of the installment manner according to the modifiable range;

(4) The client sends a client response order of the installment manner to the server online.

In steps (1) to (4), important negotiation content in the contract, and a variety of offer schemes provided by the merchant are stored in the server for later use. The purpose is to fix the content required by the merchant to be unchanged, reduce a negotiation procedure of core transaction content of the contract, make the core transaction content of the contract into a standardized form list, and make the transaction content clear and comparable. In addition, a negotiable change range of each item is attached; and a counter-offer range of the client is standardized, thereby reducing a mutual response range of online operations between the merchant and the client, and saving the negotiation procedure and time.

(5) The server makes corrections of client response content and adds a client identity: the server uses an order management module saved in the inventory to compute whether the number of installments, commodity number, price and so on in the client response order are reasonable, changes the reasonable client response order to a client response order list and then requests to invoke client identity data saved in the inventory; and the server merges and synthesizes the client response order list and the client identity data into a unmodifiable overall client order module having the client identity and the client response order list; and as for the unreasonable client response order, the server sends the original client response order to the client, deletes the client response order saved in the server in step “(4)”, and notifies the client to restart step “(3)”;

(6) The server checks the overall client order module and changes same into an invokable format: the server invokes the modifiable range of all merchant offer order list content corresponding to the number of installments in step “(2)”, and checks whether the overall client order module in step “(5)” is within the modifiable range set by the merchant offer order list; if the range is not exceeded, the server sends the overall client order module to the client for online reading and waits for confirmation; after the client confirms the overall client order module online and sends back a confirmation instruction, the server changes the module into an invokable overall client order module for storage and later use; and if the modifiable range is exceeded, the server deletes the overall client order module, sends the merchant offer order list in step “(2)” to the client and returns to step “(3)” for re-filling of the response order by the client. If the client does not confirm the overall client order module online, the server also sends the merchant offer order list in step “(2)” to the client and returns to step “(3)” for re-filling of the response order by the client. This step is a step for the client to finally determine a certain installment pre-sale offer to be responded to; if the client does not confirm the overall client order module online, a system will deduct one “client golden bean” of the client; the server sends the invokable overall client order module to the merchant; and if the merchant does not confirm the invokable overall client order module online, the system will deduct one “merchant golden bean” of the merchant;

if all the ten “client golden beans” of the client are deducted, the client cannot open a meeting response within two days as for the offer of the merchant; and the number of the “merchant golden beans” of the merchant directly reminds the client of reliability of the merchant offer;

(7) The server adds an executable agreement having payment execution content to the overall client order module: the server invokes the invokable overall online client order module in step “(6)”, invokes merchant identity data of the offer in a public database of the server, invokes a payment link and a payment record module of a bank in the public database of the server, Alipay, or WeChat, and combines into an overall agreement module of both parties having the client and merchant identities and payment management as an executable agreement.

In steps (5) to (7), the server checks the response that conforms to the offer and checks consistency with the offer content, increases the client identity, increases a client payment tool, limits change times of the response content of the client by the “client golden bean” of the client, and improves response efficiency.

(8) The server splits the overall agreement module of both parties into multiple pre-sale sub-agreements for executing payment: the overall agreement module of both parties is split into multiple pre-sale sub-agreements having payment execution; and the sub-agreement of each installment comprises the unmodifiable client and merchant identity data, the agreement for the installment, and a multiple installment payment sub-agreement list module of payment links and payment records of the modifiable platform bank or the platform Alipay or the platform WeChat.

(9) The server stores the overall agreement module of both parties and the installment payment sub-agreement list module into a database with a combined name of the client and the merchant, namely a database of directories of both parties.

(10) The server sends the installment payment sub-agreement list module to the merchant for online reading.

In steps (8) to (10), the server splits the overall agreement module of both parties into the multiple pre-sale sub-agreements capable of executing payment, that is, an overall business transaction agreement is split into multiple transaction agreements, each of which contains identity information of both parties, transaction content, payment for executing an transaction, etc. The server combines the content involved in the transaction into multiple sub-agreement lists, which is convenient for both parties to read and check an execution procedure position of the contract in the future.

(11) The merchant and the server change the agreement into a contract: the merchant selects and invokes a pre-sale contract module stored in the server database from the server online; the merchant modifies modifiable items in the selected pre-sale contract module list online; the server automatically juxtaposes the modified clauses with the original clauses, automatically loads the original clauses into red and lists same behind the modified clauses to provide modified reference content for the client; the merchant presses a contract generation button online; the server automatically synthesizes three modules, namely the modified pre-sale contract module, as well as the unmodifiable overall agreement module of both parties and the installment payment sub-agreement list module in step “(9)” into a first version of contract of the merchant and sends same to the merchant; and the merchant uses the button online to send the first version of contract of the merchant to the client;

(12) The client and the server change the agreement into a contract: the client checks the first version of contract of the merchant online, and modifies modifiable items in the pre-sale contract module list; the server automatically loads the original clauses of the modified items into blue and lists same behind the modified clauses to become a first version of contract of the client; and the client uses the button online to send the first version of contract of the client to the merchant;

(13) The client and the merchant modify the contract cyclically: the client and the merchant modify the modifiable content in the pre-sale contract module cyclically online; steps (11) and (12) are cycled; if the client approves no modification online, the client presses a “no modification as confirmed” button; and if the merchant approves no modification online, the merchant presses the “no modification as confirmed” button;

(14) The server generates an unmodifiable contract: after the server receives two pieces of “no modification as confirmed” information showing no modification approved by the client and the merchant online, the server deletes the red and blue content in the last version of contract agreed by both parties, and generates an unmodifiable pre-sale contract of both parties.

In steps (11) to (13), a large number of contract templates are stored in the server; after the server reads a product, according to product attributes such as vulnerability, a volume, handling requirements and a validity period, and the installment payment sub-agreement content in step (8), the server selects several suitable contract templates in a mechanized manner and provides same to the merchant for selection and use; the merchant selects one contract template and then modifies the clauses; the content before and after the modification of the clauses by the merchant and the client is recorded in the contract in a negotiation stage; and the deleted and modified content is recorded, which is beneficial to honest negotiation and reduces the negotiation procedure and time.

(15) The client and the merchant perform unilateral sealing: the client and the merchant respectively make network seals on the unmodifiable pre-sale contract of both parties in step “(14)” to form a network signing document or upload an image document of the contract to the server after downloading, printing and sealing; and the server saves the sealed document in the database of directories of both parties in step “(9)”;

(16) The client and the merchant perform bilateral sealing: the server receives the unmodifiable pre-sale contract of both parties, which is unilaterally sealed by the client and the merchant, and transfers same to the other party respectively; the client and the merchant respectively make network seals on the unmodifiable pre-sale contract of both parties, which is unilaterally sealed by the other party, or upload same to the server after downloading, printing and sealing; and the server obtains an image document of the pre-sale contract of both parties with effective sealing of both parties, and saves same in the database of directories of both parties in step “(9)”.

In steps (14) to (16), final legal steps of the contract are performed; and the contract takes effect after sealing.

(17) The server makes a contract execution reminder module: the server invokes a contract execution reminder module in the inventory, then invokes the installment payment sub-agreement list module in step “(9)”, and changes the installment payment sub-agreement list module into an execution reminder installment payment sub-agreement list module, which becomes a sub-agreement list execution reminder module with a payment time reminder and a delivery time reminder in the sub-agreement list module of each pre-sale installment, as well as a contact mobile phone number, WeChat and an SMS execution time reminder for receiving and delivering.

Step (17) is a follow-up service of the pre-sale platform, which extracts multiple agreement time in the contract as a reminder schedule for executing the contract, so as to prevent delay behaviors of both parties and make the contract be executed smoothly.

According to the present invention, from the merchant offer order list formed after filling in the original order module provided by the merchant server, and through operations such as filling and meeting of the merchant and a user in software of the present invention, the server finally makes the sub-agreement list module through 21 forms of documents and modules. The present invention mainly comprises installment and integration processing of the business offer content, as well as processing such as arrangements of invoking positions of data such as the business offer content and client identity data, merchant identity data, monetary payment tools, and a pre-sale contract basic content module. Therefore, the main multi-negotiation content is formed in a commercial contract; the content is processed separately from general content without negotiation and non-negotiable content; and a standardized combination is formed by assembly at appropriate steps and positions, which greatly reduces the time for forming the contract, reduces wrong clauses, enables the contract to be approved by both parties, and avoids unilateral interpretation in contract execution.

(1) Merchant offer order list: it is a list with multiple categories, such as multiple lists according to the quantity of pre-sell goods, a multiple list according to delivery time, and a multiple list according to price changes; there are installments in each multiple list; and each pre-sale period has offer contents set by the merchant, such as the quantity and a quantitatively variable range of the goods, the delivery time and a front-back variable range, a price and a quantitatively variable range;

(2) Client response order: it is a list of an item in the merchant offer order list according to modification forms of the client;

(3) Client response order list: the server corrects the client response order and changes the reasonable client response order into the client response order list;

(4) Client identity data: including client information required for concluding the contract, such as name, land concession, business license number . . . ;

(5) Client identity and client response order list;

(6) Overall client order module: it is a combined list of the client identity and client response order list;

(7) Invokable overall client order module: saved as a permanent storage format that can be executed by the contract and can be invoked;

(8) Merchant identity data: including client information required for concluding the contract, such as name, land concession, business license number . . . ;

(9) Payment link and payment record module of a bank, Alipay or WeChat: a payment tool that can be connected with merchant and client accounts;

(10) Overall agreement module of both parties: saved as a permanent storage format that can be executed by the contract and can be invoked;

(11) Pre-sale sub-agreement for executing payment: a list of business content with a payment function;

(12) Installment payment sub-agreement list module: an assembly of multiple lists of business content such as installment payment and installment delivery, and final confirmation content of main business content negotiation;

(13) Pre-sale contract module: it is a contract database stored in the server that can be invoked by uncertain people; and according to content such as the commodity type, quantity, volume, fragility, price, payment time and means in the above item “installment payment sub-agreement list module”, the server searches and optimizes some contract templates in the contract database and recommends same to the merchant;

(14) First version of contract of the merchant: the contract sent to the user after the merchant selects one contract template recommended by the server for modification;

(15) Contract agreed by both parties: a contractual documents confirmed by both the merchant and the client;

(16) Unmodifiable pre-sale contract of both parties: a storage format of the contract is not modified; and the contract has a function of files to be checked;

(17) Valid pre-sale contract of two parties: a legally effective contract sealed by both the merchant and the client;

(18) Contract execution reminder module;

(19) Installment payment sub-agreement list module;

(20) Execution reminder installment payment sub-agreement list module: a connection module mainly having multiple installment time and corresponding execution items and communication tools of both parties;

(21) Sub-agreement list module.

The present invention has the advantages: various offers of the merchant are issued to an uncertain client as unchangeable acknowledged content of the merchant; the “golden bean” management of the merchant and the client minimizes reverse negotiation and efficiently generates a pre-sale contract; the merchant and the client communicate online within the modifiable scope of the offer determined by the merchant; the server can correct the computable transaction content negotiated by both parties at any time to reduce an invalid negotiation process; the server automatically assembles the transaction content, the identity information of both parties, the executed payment tools, etc., thereby greatly reducing a textualization process of non-negotiable content; selection of a suitable contract template from the data of the server by using the transaction content information for both parties to negotiate also greatly reduces the textualization process of the non-negotiable content; and the follow-up contract execution reminder service of the pre-sale platform server minimizes delays in contract execution.

### DESCRIPTION OF THE DRAWINGS

FIG. 1 is a flow chart of operations of a merchant and a user and server operations that change a merchant offer order list into a multiple installment payment sub-agreement list template; and

FIG. 2 is a flow chart of operations of a merchant and a user and server operations that change a multiple installment payment sub-agreement list template into an execution reminder installment payment sub-agreement list.

### DETAILED DESCRIPTION OF PREFERRED EMBODIMENTS

### Embodiment 1 Online Generation Method for an Installment Pre-Sale Contract

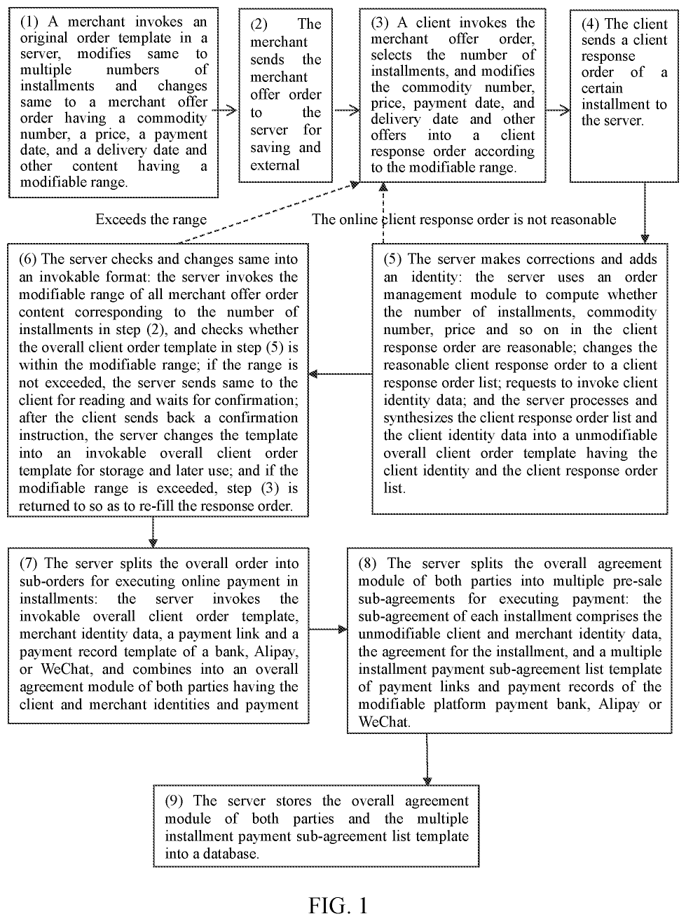

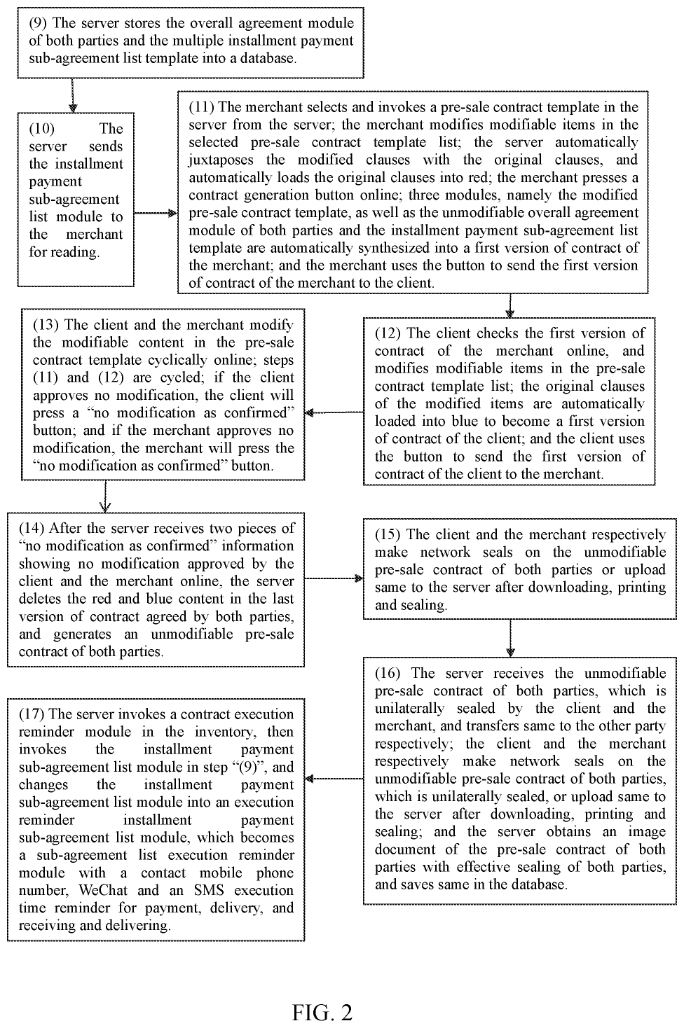

As shown in FIGS. 1 and 2, the online generation method for the installment pre-sale contract comprises: a merchant and a client online mutually send data and invoke an inventory module in a server, modify the inventory module, and complete an offer, an agreement, order generation, order installment, an executable agreement, contract generation and a contract execution reminder; and there is an online constraint method in a contract generation process. Specific steps are as follows:

(1) A merchant invokes an original order module in a server online, modifies same to multiple numbers of installments and changes same to a merchant offer order list of a multiple installment format having a commodity number, a price, a payment date, and a delivery date and other content having a modifiable range; the original order module is an invokable data packet.

(2) The merchant sends the merchant offer order list to the server for saving and external issuance; external issuance is a way of not identifying readers, and any client online can read the list.

(3) A client invokes the merchant offer order list online, selects the merchant offer order list of one installment manner in the multiple numbers of installments, and modifies the commodity number, price, payment date, and delivery date and other offer content into a client response order of the installment manner according to the modifiable range; the client is recorded in the service, and the record content is client identity data, comprising name, company name, address, telephone, WeChat, email, account and other data packets formed by necessary business transaction information.

(4) The client sends a client response order of the installment manner to the server online.

In steps (1) to (4), important negotiation content in the contract, and a variety of offer schemes provided by the merchant are stored in the server for later use. The purpose is to fix the content required by the merchant to be unchanged, reduce a negotiation procedure of core transaction content of the contract, make the core transaction content of the contract into a standardized form list, and make the transaction content clear and comparable. In addition, a negotiable change range of each item is attached; and a counter-offer range of the client is standardized, thereby reducing a mutual response range of online operations between the merchant and the client, and saving the negotiation procedure and time. The server saves the data mutually sent by the merchant or the client through a memory.

(5) The server makes corrections of client response content and adds a client identity: the server uses an order management module saved in the inventory to compute whether the number of installments, commodity number, price and so on in the client response order are reasonable, changes the reasonable client response order to a client response order list and then requests to invoke client identity data saved in the inventory; and the server merges and synthesizes the client response order list and the client identity data into a unmodifiable overall client order module having the client identity and the client response order list; and as for the unreasonable client response order, the server sends the original client response order to the client, deletes the client response order saved in the server in step “(4)”, and notifies the client to restart step “(3)”; the server makes corrections of response content, which means that the data in different memories are invoked to make corresponding comparison in a comparator, to reduce misunderstanding and misinput in negotiation, so that there is no mistake in each step of negotiation, to avoid the false recognition that is not clear or not definite in face-to-face negotiation.

(6) The server checks the overall client order module and changes same into an invokable format: the server invokes the modifiable range of all merchant offer order list content corresponding to the number of installments in step “(2)”, and checks whether the overall client order module in step “(5)” is within the modifiable range set by the merchant offer order list; if the range is not exceeded, the server sends the overall client order module to the client for online reading and waits for confirmation; after the client confirms the overall client order module online and sends back a confirmation instruction, the server changes the module into an invokable overall client order module for storage and later use; and if the modifiable range is exceeded, the server deletes the overall client order module, sends the merchant offer order list in step “(2)” to the client and returns to step “(3)” for re-filling of the response order by the client. If the client does not confirm the overall client order module online, the server also sends the merchant offer order list in step “(2)” to the client and returns to step “(3)” for re-filling of the response order by the client. This step is a step for the client to finally determine a certain installment pre-sale offer to be responded to; if the client does not confirm the overall client order module online, a system will deduct one “client golden bean” of the client; the server sends the invokable overall client order module to the merchant; and if the merchant does not confirm the invokable overall client order module online, the system will deduct one “merchant golden bean” of the merchant;

If all the ten “client golden beans” of the client are deducted, the client cannot open a meeting response within two days as for the offer of the merchant; and the number of the “merchant golden beans” of the merchant directly reminds the client of reliability of the merchant offer. The overall client order module is a long-term storage of data for reference in the transaction process, indicating that the client has completely fixed transaction content, and the client information makes a commitment for the transaction content.

(7) The server adds an executable agreement having payment execution content to the overall client order module: the server invokes the invokable overall online client order module in step “(6)”, invokes merchant identity data of the offer in a public database of the server, invokes a payment link and a payment record module of a bank in the public database of the server, Alipay, or WeChat, and combines into an overall agreement module of both parties having the client and merchant identities and payment management as an executable agreement.

In steps (5) to (7), the server checks the response that conforms to the offer and checks consistency with the offer content, increases the client identity, increases a client payment tool, limits change times of the response content of the client by the “client golden bean” of the client, and improves response efficiency. The overall agreement module of both parties comprises transaction content, content, content, identities of both parties, and payment modes, and is a commitment content that should be concluded, so it should be recorded with “golden bean”; and any return will be given a bad record.

(8) The server splits the overall agreement module of both parties into multiple pre-sale sub-agreements for executing payment: the overall agreement module of both parties is split into multiple pre-sale sub-agreements having payment execution; and the sub-agreement of each installment comprises the unmodifiable client and merchant identity data, the agreement for the installment, and a multiple installment payment sub-agreement list module of payment links and payment records of the modifiable platform bank or the platform Alipay or the platform WeChat.

Splitting is the characteristic of installment pre-sale transaction, and also one of the characteristics of the software. The varieties and prices of the overall agreement transaction are split. The splitting mode is selected according to the merchant offer order list in various templates saved in the server. The client also accepts the splitting mode, so there will be no mistake in splitting.

(9) The server stores the overall agreement module of both parties and the installment payment sub-agreement list module into a database with a combined name of the client and the merchant, namely a database of directories of both parties. This is an important unchangeable negotiation result, and thus is saved in a memory of public directories of both parties, for the convenience of invoking with public names of both parties.

(10) The server sends the installment payment sub-agreement list module to the merchant for online reading.

In steps (8) to (10), the server splits the overall agreement module of both parties into the multiple pre-sale sub-agreements capable of executing payment, that is, an overall business transaction agreement is split into multiple transaction agreements, each of which contains identity information of both parties, transaction content, payment for executing an transaction, etc. The server combines the content involved in the transaction into multiple sub-agreement lists, which is convenient for both parties to read and check an execution procedure position of the contract in the future.

(11) The merchant and the server change the agreement into a contract: the merchant selects and invokes a pre-sale contract module stored in the server database from the server online; the merchant modifies modifiable items in the selected pre-sale contract module list online; the server automatically juxtaposes the modified clauses with the original clauses, automatically loads the original clauses into red and lists same behind the modified clauses to provide modified reference content for the client; the merchant presses a contract generation button online; the server automatically synthesizes three modules, namely the modified pre-sale contract module, as well as the unmodifiable overall agreement module of both parties and the installment payment sub-agreement list module in step “(9)” into a first version of contract of the merchant and sends same to the merchant; and the merchant uses the button online to send the first version of contract of the merchant to the client.

The server stores many pre-sale contract templates, and searches the number of installments, commodity names and quantity, price, commodity volume and the distance of the addresses of the merchant and the client to place some preferred pre-sale contract modules in front for the online selection of the merchant and send these modules to the client for negotiation. Before being confirmed by both parties, the original content of the pre-sale contract module selected by the merchant online and the content modified by both parties for many times can be displayed, which is convenient to read the previous negotiation content. Only after both parties confirm that the modification is completed, the best confirmed content of both parties can be retained.

(12) The client and the server change the agreement into a contract: the client checks the first version of contract of the merchant online, and modifies modifiable items in the pre-sale contract module list; the server automatically loads the original clauses of the modified items into blue and lists same behind the modified clauses to become a first version of contract of the client; and the client uses the button online to send the first version of contract of the client to the merchant.

(13) The client and the merchant modify the contract cyclically: the client and the merchant modify the modifiable content in the pre-sale contract module cyclically online; steps (11) and (12) are cycled; if the client approves no modification online, the client presses a “no modification as confirmed” button; and if the merchant approves no modification online, the merchant presses the “no modification as confirmed” button.

(14) The server generates an unmodifiable contract: after the server receives two pieces of “no modification as confirmed” information showing no modification approved by the client and the merchant online, the server deletes the red and blue content in the last version of contract agreed by both parties, and generates an unmodifiable pre-sale contract of both parties.

In steps (11) to (13), a large number of contract templates are stored in the server; after the server reads a product, according to product attributes such as vulnerability, a volume, handling requirements and a validity period, and the installment payment sub-agreement content in step (8), the server selects several suitable contract templates in a mechanized manner and provides same to the merchant for selection and use; the merchant selects one contract template and then modifies the clauses; the content before and after the modification of the clauses by the merchant and the client is recorded in the contract in a negotiation stage; and the deleted and modified content is recorded, which is beneficial to honest negotiation and reduces the negotiation procedure and time. The unmodifiable pre-sale contract of both parties indicates a contract that has been negotiated and waits for a seal to execute the transaction.

(15) The client and the merchant perform unilateral sealing: the client and the merchant respectively make network seals on the unmodifiable pre-sale contract of both parties in step “(14)” to form a network signing document or upload an image document of the contract to the server after downloading, printing and sealing; and the server saves the sealed document in the database of directories of both parties in step “(9)”.

(16) The client and the merchant perform bilateral sealing: the server receives the unmodifiable pre-sale contract of both parties, which is unilaterally sealed by the client and the merchant, and transfers same to the other party respectively; the client and the merchant respectively make network seals on the unmodifiable pre-sale contract of both parties, which is unilaterally sealed by the other party, or upload same to the server after downloading, printing and sealing; and the server obtains an image document of the pre-sale contract of both parties with effective sealing of both parties, and saves same in the database of directories of both parties in step “(9)”.

In steps (14) to (16), final legal steps of the contract are performed; and the contract takes effect after sealing.

(17) The server makes a contract execution reminder module: the server invokes a contract execution reminder module in the inventory, then invokes the installment payment sub-agreement list module in step “(9)”, and changes the installment payment sub-agreement list module into an execution reminder installment payment sub-agreement list module, which becomes a sub-agreement list execution reminder module with a payment time reminder and a delivery time reminder in the sub-agreement list module of each pre-sale installment, as well as a contact mobile phone number, WeChat and an SMS execution time reminder for receiving and delivering.

Step (17) is a follow-up service of the pre-sale platform, which extracts multiple agreement time in the contract as a reminder schedule for executing the contract, so as to prevent delay behaviors of both parties and make the contract be executed smoothly.

We claim:

1. An online generation method for an installment pre-sale contract, comprising: a merchant and a client online mutually send data and invoke an inventory module in a server, modify the inventory module, and complete an offer, an agreement, order generation, order installment, an executable agreement, contract generation and a contract execution reminder, comprising the following specific steps:
(1) a merchant invokes an original order module in a server online, modifies same to multiple numbers of installments and changes same to a merchant offer order list of a multiple installment format having a commodity number, a price, a payment date, a delivery date and other content having a modifiable range;
(2) the merchant sends the merchant offer order list to the server for saving and external issuance;
(3) a client invokes the merchant offer order list online, selects the merchant offer order list of one installment manner in the multiple numbers of installments, and modifies the commodity number, the price, the payment date, the delivery date and other offer content into a client response order of the installment manner according to the modifiable range;
(4) the client sends a client response order of an installment manner to the server online;
(5) the server makes corrections of client response content and adds a client identity: the server uses an order management module saved in the inventory to compute whether the number of installments, commodity number, price and so on in the client response order are reasonable, changes the reasonable client response order to a client response order list, and then requests to invoke client identity data saved in the inventory; the server merges and synthesizes the client response order list and the client identity data into a unmodifiable overall client order module having the client identity and the client response order list; and as for the unreasonable client response order, the server sends the original client response order to the client, deletes the client response order saved in the server in step “(4)”, and notifies the client to restart step “(3)”;
(6) the server checks the overall client order module and changes same into an invokable format: the server invokes the modifiable range of all merchant offer order list content corresponding to the number of installments in step “(2)”, and checks whether the overall client order module in step “(5)” is within the modifiable range which is set by the merchant offer order list; if the range is not exceeded, the server sends the overall client order module to the client for online reading and waits for confirmation; after the client confirms the overall client order module online and sends back a confirmation instruction, the server changes the module into an invokable overall client order module for storage and later use; if the modifiable range is exceeded, the server deletes the overall client order module, sends the merchant offer order list in step “(2)” to the client and returns to step “(3)” for re-filling of the response order by the client; if the client does not confirm the overall client order module online, the server also sends the merchant offer order list in step “(2)” to the client and returns to step “(3)” for re-filling of the response order by the client; the step is a step for the client to finally determine a certain installment pre-sale offer to be responded to; if the client does not confirm the overall client order module online, a system deducts one “client golden bean” of the client; the server sends the invokable overall client order module to the merchant; and if the merchant does not confirm the invokable overall client order module online, the system deducts one “merchant golden bean” of the merchant;
(7) the server adds an executable agreement having payment execution content to the overall client order module: the server invokes the invokable overall online client order module in step “(6)”, invokes merchant identity data of the offer in a public database of the server, invokes a payment link and a payment record module of a bank in the public database of the server, Alipay, or WeChat, and combines into an overall agreement module of both parties having the client and merchant identities and payment management as an executable agreement;
(8) the server splits the overall agreement module of both parties into multiple pre-sale sub-agreements for executing payment: the overall agreement module of both parties is split into multiple pre-sale sub-agreements having payment execution; and the sub-agreement of each installment comprises the unmodifiable client and merchant identity data, the agreement for the installment, and a multiple installment payment sub-agreement list module of payment links and payment records of the modifiable platform bank or the platform Alipay or the platform WeChat;
(9) the server stores the overall agreement module of both parties and the installment payment sub-agreement list module into a database with a combined name of the client and the merchant, namely a database of directories of both parties;
(10) the server sends the installment payment sub-agreement list module to the merchant for online reading;
(11) the merchant and the server change the agreement into a contract: the merchant selects and invokes a pre-sale contract module stored in the server database from the server online; the merchant modifies modifiable items in the selected pre-sale contract module list online; the server automatically juxtaposes the modified clauses with the original clauses, automatically loads the original clauses into red and lists same behind the modified clauses to provide modified reference content for the client; the merchant presses a contract generation button online; the server automatically synthesizes three modules, namely the modified pre-sale contract module, as well as the unmodifiable overall agreement module of both parties and the installment payment sub-agreement list module in step “(9)” into a first version of contract of the merchant and sends same to the merchant; and the merchant uses the button online to send the first version of contract of the merchant to the client;
(12) the client and the server change the agreement into a contract: the client checks the first version of contract of the merchant online, and modifies modifiable items in the pre-sale contract module list; the server automatically loads the original clauses of the modified items into blue and lists same behind the modified clauses to become a first version of contract of the client; and the client uses the button online to send the first version of contract of the client to the merchant;
(13) the client and the merchant modify the contract cyclically: the client and the merchant modify the modifiable content in the pre-sale contract module cyclically online; steps (11) and (12) are cycled; if the client approves no modification online, the client presses a “no modification as confirmed” button; and if the merchant approves no modification online, the merchant presses the “no modification as confirmed” button;
(14) the server generates an unmodifiable contract: after the server receives two pieces of “no modification as confirmed” information showing no modification approved by the client and the merchant online, the server deletes the red and blue content in the last version of contract agreed by both parties, and generates an unmodifiable pre-sale contract of both parties;
(15) the client and the merchant perform unilateral sealing: the client and the merchant respectively make network seals on the unmodifiable pre-sale contract of both parties in step “(14)” to form a network signing document or upload an image document of the contract to the server after downloading, printing and sealing; and the server saves the sealed document in the database of directories of both parties in step “(9)”;
(16) the client and the merchant perform bilateral sealing: the server receives the unmodifiable pre-sale contract of both parties, which is unilaterally sealed by the client and the merchant, and transfers same to the other party respectively; the client and the merchant respectively make network seals on the unmodifiable pre-sale contract of both parties, which is unilaterally sealed by the other party, or upload same to the server after downloading, printing and sealing; and the server obtains an image document of the pre-sale contract of both parties with effective sealing of both parties, and saves same in the database of directories of both parties in step “(9)”;
(17) the server makes a contract execution reminder module: the server invokes a contract execution reminder module in the inventory, then invokes the installment payment sub-agreement list module in step “(9)”, and changes the installment payment sub-agreement list module into an execution reminder installment payment sub-agreement list module, which becomes a sub-agreement list execution reminder module with a payment time reminder and a delivery time reminder in the sub-agreement list module of each pre-sale installment, as well as a contact mobile phone number, WeChat and an SMS execution time reminder for receiving and delivering.
